(19) United States
(12) Patent Application Publication
(10) Pub. No.: US 2023/0316349 A1
(43) Pub. Date: Oct. 5, 2023

(54) MACHINE-LEARNING MODEL TO CLASSIFY TRANSACTIONS AND ESTIMATE LIABILITIES

(71) Applicant: Tide Platform Limited, London (GB)

(72) Inventor: Ratheen Chaturvedi, Mumbai (IN)

(21) Appl. No.: 17/851,258

(22) Filed: Jun. 28, 2022

(30) Foreign Application Priority Data
Apr. 5, 2022 (IN) 202241020470

(51) Int. Cl. G06Q 30/04

(52) U.S. Cl. CPC G06Q 30/04; G06N 20/00

(57) ABSTRACT

A transaction classification model is trained using historical transaction and account data to predict classifications of transactions. When the model is deployed, a transaction review device receives transaction data and account data for an account. The transaction classification model is applied to the transaction data and the account data to generate predicted classifications for at least some of the transactions identified in the account data. A tax liability is estimated based on the predicted classifications and the tax liability estimate is provided for display at the transaction review device.

### CROSS REFERENCE TO RELATED APPLICATIONS

This application claims the right of priority based on India application no. 2022/41020470, filed Apr. 5, 2022, which is incorporated by reference.

### BACKGROUND

### 1. Technical Field

The subject matter described relates generally to machine-learning and, in particular, to a model for classifying transactions and predicting corresponding tax liabilities.

### 2. Problem

Businesses and other entities engage is large numbers of transactions every day, such as paying wages and salaries, receiving payment for products, paying for products and components, issuing and receiving loans, paying and receiving dividends, reimbursing expenses, paying and receiving payment for service, and the like. Many of these transactions have an impact of the entity's tax liabilities. The precise impact depends on how the transaction is classified. Traditionally, accounting departments maintain large spreadsheets and manually classify each transaction. However, such approaches are time consuming and prone to human error. Furthermore, different entities often use different classification systems and different jurisdictions may treat similar transactions differently for tax purposes.

### SUMMARY

The above and other problems may be addressed by a system and method for automatically classifying transactions using a machine-learning model. The system and method may also estimate a tax liability for an entity based on the entity's classified transactions. By using the machine-learned model, the transactions may be consistently and efficiently classified, enabling greater confidence in the estimated tax liability with significantly less human effort and reduce the likelihood of human errors impacting the estimate.

In one embodiment, a computer-implemented method for classifying transactions includes receiving transaction data and account data for an account. The transaction data includes data describing transactions involving the account. The method also includes applying a machine-learning transaction classification model to the transaction data and the account data to generate predicted classifications for at least some of the transactions. A tax liability is estimated based on the predicted classifications. The tax liability estimate is provided for display.

### BRIEF DESCRIPTION OF THE DRAWINGS

FIG. 1 is a block diagram of a networked computing environment suitable for deployment of a transaction classification model, according to one embodiment.

FIG. 2 is a block diagram of the server of FIG. 1, according to one embodiment.

FIG. 3 is a flowchart of a method for training a machine-learning model to predict classifications for transactions, according to one embodiment.

FIG. 4 is a flowchart of a method for evaluating the tax liability of an account using a transaction classification model, according to one embodiment.

FIG. 5 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Overview

As described previously, existing approaches for classifying transactions are time-intensive and prone to human error. Significant efficiencies may be realized by adopting machine-learning techniques to classify transactions. In the following disclosure, for convenience and clarity, various embodiments are described that relate to classifying transactions for the purpose of estimating tax liabilities. However, it should be appreciated that the same or similar techniques may be used to classify transactions for other purposes.

In one embodiment, a machine-learning transaction classification model is trained to predict classifications for transactions using labelled training data. The features used by the transaction classification model may include information about the specific transaction (e.g., amount, payer, payee, merchant details, transaction type, method of payment, payment reference, or transaction description, etc.) and information about the specific entity for which transactions are being classified (e.g., average transaction amount, minimum transaction amount for the entity, maximum transaction amount for the entity, total transaction value in a given time period, number of transactions in a given time period, industry in which the entity operates, or SIC description of the entity, etc.).

Once deployed, the trained transaction classification model is applied to transactions for an entity or account to generate one or more predicted classifications for those transactions. Some or all of the predicted classifications may be presented to a user for confirmation. The classifications may be the same as classifications used by a relevant tax authority or the classifications generated by the transaction classification model may be mapped to the relevant tax-authority classifications. Thus, in some embodiments, the tax liability resulting from the transactions may be estimated.

### Example Systems

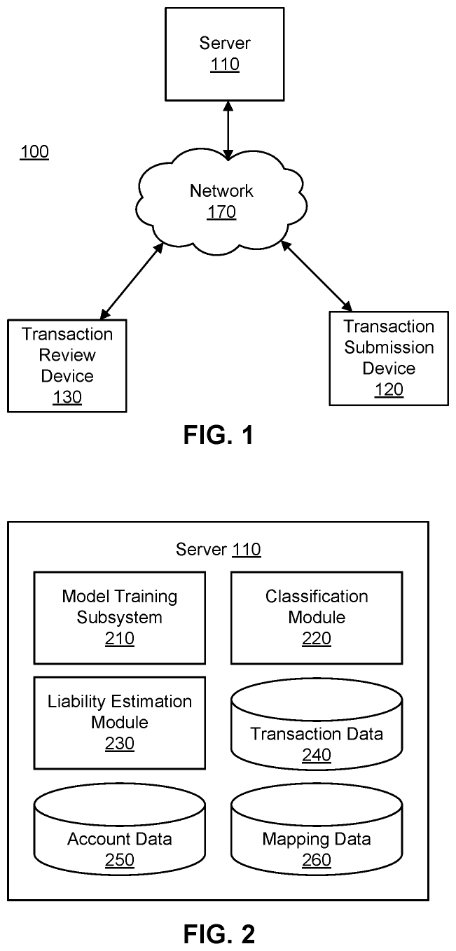

FIG. 1 illustrates one embodiment of a networked computing environment 100 environment suitable for deployment of a transaction classification model. In the embodiment shown, the networked computing environment 100 includes a server 110, a transaction submission device 120, and a transaction review device 130, all connected via a network 170. In other embodiments, the networked computing environment 100 includes different or additional elements. Although only one transaction submission device 120 and one transaction review device 130 are shown, the networked computing environment 100 may include any number of each type of device. Furthermore, other embodiments of the networked computing environment 100 may include different or additional elements. In addition, the functions may be distributed among the elements in a different manner than described. For example, the functionally attributed below to the transaction submission device 120 and the transaction review device 130 may be provided by a single device.

The server 110 is one or more computing devices with which a provider provides a transaction management service to one or more organizations (e.g., businesses, non-profit organizations, educational institutions, etc.). Each organization has an account with the provider that tracks transactions involving the organization. In one embodiment, the server 110 applies a machine-learning transaction classification model to classify the transactions of an account. Some or all of the generated classifications may be presented to a user for confirmation. The server 110 may also map the confirmed classifications to tax classifications and estimate a tax liability for the organization due to the classified transactions. Various embodiments of the server 110 are described in greater detail below, with reference to FIG. 2.

A transaction submission device 120 may be any computing device suitable for providing a user interface with which a user associated with an organization (e.g., an employee) may initiate transactions or provide information about transactions to the server 110. It should be understood that references to actions taken by an organization mean actions taken by a human on behalf of the organization unless the context indicates otherwise. An organization signs up for an account with the provider and is assigned or provides a unique identifier for the account (e.g., an account ID). An organization may initiate transactions (e.g., sending and receiving transfers of money) using the transaction management service. Additionally or alternatively, a user associated with an organization may submit details of transactions made using other service providers to be associated with the organization's account. For example, the organization may receive payments from customers and pay vendors using the transaction management service but mange payroll and employee expenses through a third party service and import data describing the corresponding transactions into the transaction management service.

A transaction review device 130 may be any computing device suitable for providing a user interface with which a user associated with an organization (e.g., a finance manager) may review information about the organization's transactions that is stored at the server 110. In one embodiment, the user interface for reviewing transactions enables the user to query all transactions associated with an account and review the details of those transactions (e.g., date, amount, parties, etc.). The transaction review device 130 may also provide, as part of the same or a different user interface, predicted classifications for transactions generated by the server 110 for the user to confirm. If the certainty associated with a predicted classification for a transaction is below a threshold, the user interface may instead present the transaction as unclassified and prompt the user to manually select a classification. The same or a different user interface may also enable the user to view an estimated tax liability resulting from the transactions associated with the account based on a mapping between the classifications of the transactions provided by the server (e.g., using a classification system defined by the organization or the provider) and a classification system used by the relevant tax authority.

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

FIG. 2 illustrates one embodiment of the server 110. In the embodiment shown, the server 110 includes a model training subsystem 210, a classification module 220, a liability estimation module 230, and datastores for transaction data 240, account data 20, and mapping data 260. In other embodiments, the server 110 includes different or additional elements. In addition, the functions may be distributed among the elements in a different manner than described.

The model training subsystem 210 trains a machine-learning model to predict classifications for transactions. Although the model training subsystem 210 is shown as part of the server 110 for convenience, the model training subsystem may be a separate computing device that train the transaction classification model which is then transferred to the server 110 (e.g., via the network 170). The transaction classification model takes data describing a transaction and data regarding the corresponding account as input and outputs one or more risk classification predictions for the transaction. Each classification may identify a classification and a likelihood of the classification being correct. If no classification has a likelihood greater than a threshold, the transaction classification model may output no predicted classification. In one embodiment, the data describing the transaction includes one or more of: a transaction amount, a payer, a payee, merchant details, a PPS transaction type, a payment method, an acceptance method, an identifier of the payment, or a description of the transaction, etc. The data regarding the corresponding account may include one or more of: an average transaction amount (mean, median, etc.), minimum and maximum amounts of transactions made historically from the account, a total amount of transactions for a preceding time period, an industry classification of the organization that holds the account, or an SIC description of the organization, etc.

In various embodiments, the model training subsystem 210 uses historical data stored in the transaction data 240 and the account data 250 as training data for the transaction classification model. The historical transactions may be labelled with the correct categories by the organization as part of a manual categorization process, the provider (e.g., by people hired specifically to label training data), or a combination of both (e.g., the data may be labelled by organization and verified by the provider). The model training subsystem 210 iteratively trains the transaction classification model to predict classifications for the historical transaction data 240 and account data 250 as input. Specifically, the transaction classification model may output predicted classifications for the historical transactions, compare the predictions to the ground truth labels, and update the transaction classification model by attempting to minimize a cost function that quantifies the aggregate difference between the predictions and ground truth. For example, each prediction may include probabilities that one or more classifications apply to a transaction and the cost function may be the sum of the difference in squares between the predicted probability and the ground truth (one if the classification is correct and zero otherwise).

In one embodiment, the transaction classification model is a neural network, but any suitable machine-learning model may be used, such as a random forest, gradient-boosted decision tree, support vector machine, logistic regression, nearest neighbor model, or naïve Bayes classifier, etc.

Regardless of the precise nature of the transaction classification model and training methods used, the output from the model training subsystem 210 is a trained machine-learning model that, given a set of transaction data 240 and account data 250 for a transaction can predict the classification of the transaction. The trained transaction classification model may be stored for future use. The transaction classification model may be periodically retrained as more training data becomes available (e.g., as more accounts are opened and more transactions take place).

The classification module 220 applies the trained transaction classification model to predict classifications for transactions of accounts. In one embodiment, the classification module 220 may predict classifications for transactions as the transactions occur or are imported into the server 110. Alternatively, the classification module 220 may periodically (e.g., daily, weekly, or monthly, etc.) predict classifications for each transaction involving an account made since the last periodic classification. In either case, as described previously, the prediction for a transaction may include a likelihood that each of one or more classifications apply (e.g., a likelihood that each possible classification applies). The classification module 220 may select the most likely classification as the predicted classification for a transaction or store a certain number of the most likely classifications (e.g., the top three most likely) in association with the transaction. In some embodiments, likelihoods below a threshold are ignored. Thus some transactions may not have a predicted classification if none of the classifications exceed the threshold likelihood.

In some embodiments, the classification module 220 causes one or more predicted classifications for transactions to be presented to a user (e.g., at a transaction review device 130) for confirmation. For example, the user may be presented a user interface on a screen of the device 130 including a list of transactions associated with an account and a predicted classification (or an indication of no classification) for each transaction. The prediction may be displayed with an indication of the likelihood of the prediction. Where multiple predicted classifications are relevant (e.g., where multiple classifications were predicted with more than a threshold likelihood), all of the relevant classifications may be displayed in conjunction with indications of the corresponding likelihoods. The user interface may include controls with which the user can confirm the predicted classification or select an alternative classification (e.g., by selecting a desired classification from a dropdown list).

The liability estimation module 230 estimates the tax liability for an account due to the transactions involving the account using the transaction classifications generated by the classification module 220. In one embodiment, the classification module 220 generates classifications that are used by the relevant tax authority or authorities. Thus, the liability estimation module 230 can estimate the tax liability by summing the transactions in each category and applying the appropriate tax rules for the jurisdiction.

In another embodiment, the classifications generated by the liability estimation module 230 are different than those used by the relevant tax authority (e.g., the classification scheme used is defined by the account holder or provider). In this case, the liability estimation module 230 maps the transaction classifications generated by the classification module 220 to the classifications used by the tax authority using a classifications mapping (e.g., stored in the mapping data 260). This enables the liability estimation module to be easily and rapidly updated to estimate tax liabilities for new jurisdictions, changes in tax codes, and changes in the classification scheme used by the classification module 220. The provider simply defines a mapping between the classification system used by the classification module and the classifications used by the relevant tax authority (or authorities) and directs the liability estimation module 230 to use the new mapping for a specified account (e.g., by setting a parameter associated with the account).

The transaction data 240, account data 250, and mapping data 260 are each stored in one or more computer-readable media. Although the transaction data 240, account data 250, and mapping data 260 are each shown as being stored in separate datastores, in some embodiments, all of the data is stored in a single datastore. Furthermore, although the data is shown as being stored within the server 110, some or all of the data may be stored elsewhere and accessed via the network 17 (e.g., the data may be stored in a distributed database).

### Example Methods

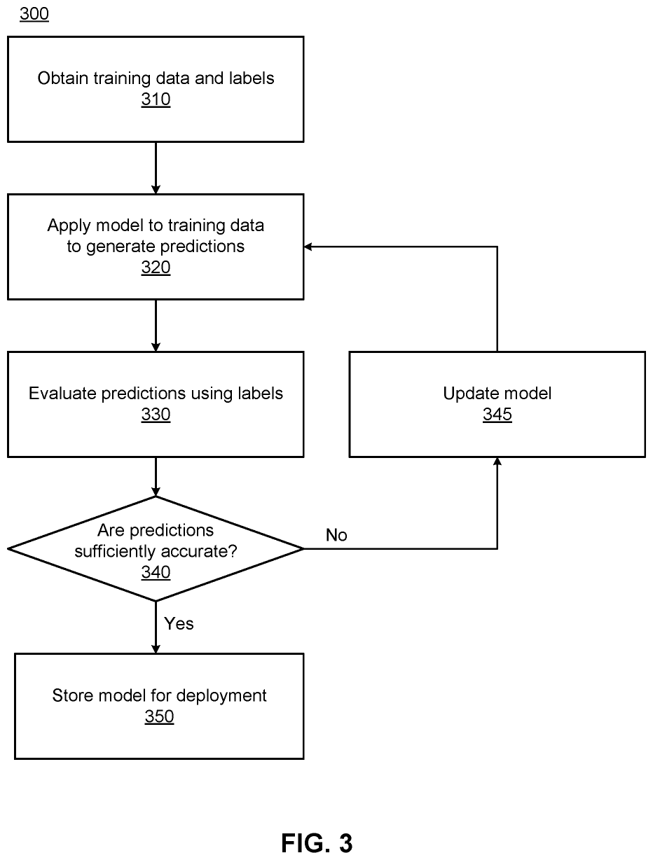

FIG. 3 illustrates a method 300 for training a machine-learning model for classifying transactions, according to one embodiment. The steps of FIG. 3 are illustrated from the perspective of the model training subsystem 210 performing the method 300. However, some or all of the steps may be performed by other entities or components. In addition, some embodiments may perform the steps in parallel, perform the steps in different orders, or perform different steps.

In the embodiment shown in FIG. 3, the method 300 begins with the model training subsystem 210 obtaining 310 training data and labels. The training data includes information about a set of transactions and the corresponding accounts. The labels in this context are data indicating the correct classifications of the transactions. The model training subsystem 210 applies 320 the transaction classification model to the training data to generate predicted classifications for the transactions and evaluates 330 the predictions using the labels. If the transaction classification model can correctly predict the classifications of the transactions to some specified degree of correctness using information about those transactions and information about the corresponding account then the transaction classification model is well fitted to the training data.

The model training subsystem 210 determine 340 whether the predictions are sufficiently accurate. This determination may be based on one or more metrics. For example, the model training system 210 may calculate the number of false positives (predictions that predictions that a classification applies when it does not), the number of false negatives (predictions that a classification does not apply when it does), a number of correct predictions, the percentage of predictions that are correct, a number of incorrect predictions, the percentage of predictions that are incorrect, a precision score, a recall score, an F1 score, or any other metric indicative of how well the transaction classification model is trained to match the training data. The model training subsystem 210 may compare the metrics to one or more criteria to determine 330 whether the predictions are sufficiently accurate. For example, in one embodiment, precision, recall, and F1 scores may all be required to be greater than corresponding thresholds for a determination that the predictions to be considered sufficiently accurate.

If the predictions are determined 340 to not be sufficiently accurate, the model training subsystem 210 updates 345 the transaction classification model. The model may be updated to reduce the error in the predictions using any suitable algorithm (e.g., a backpropagation algorithm). In one embodiment, the model update algorithm seeks to minimize a cost function defined as:

$$- {\sum }_{i = 1}^{m} {\sum }_{k = 0}^{1} 1 \{ {y}^{( i )} = k \} log P ( {y}^{( i )} = k \vert {x}^{( i )} ; θ )$$

Here k is the number of classes (e.g., a number of formal tax categories) and m is the number of observations (e.g., in millions). If 1{y=True Label} becomes 1, and 1{y=FalseLabel} becomes 0, P(y=k) is the probability of that transaction belonging to class k given the feature vector x and calculated model parameters (represented by θ). This process iterates with the model being applied 320 to the training data, the resulting predictions being evaluated 330, and the model parameters are updated 345 until the model training subsystem 210 determines 340 that the predictions are sufficiently accurate (i.e., one or more accuracy criteria are met). Additionally or alternatively, the model may be trained for a fixed number of cycles before training ends. Regardless of the precise condition or conditions used to end training, the model is stored 350 for deployment.

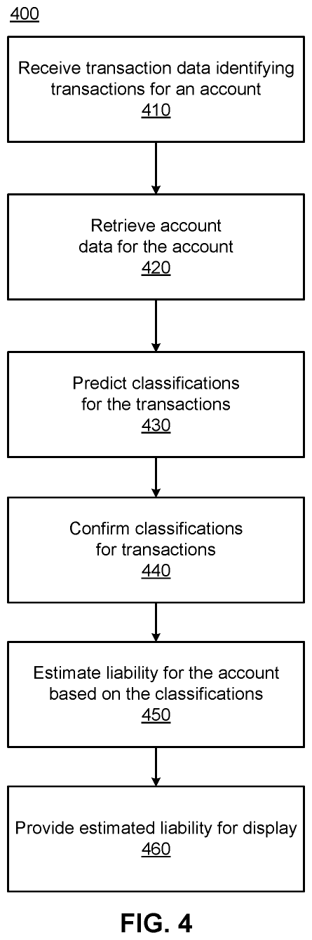

FIG. 4 illustrates a method 400 for evaluating the tax liability of an account using a transaction classification model, according to one embodiment. The steps of FIG. 4 are illustrated from the perspective of the liability estimation module 230 performing the method 400. However, some or all of the steps may be performed by other entities or components. In addition, some embodiments may perform the steps in parallel, perform the steps in different orders, or perform different steps.

In the embodiment shown in FIG. 4, the method 400 begins with the liability estimation module 230 receiving 410 transaction data. The transaction data identifies transactions for an account (e.g., all transactions involving the account). The transaction data 410 may be retrieved in response to the user executing a transaction review application or navigating to a portion of a user interface for reviewing transactions, etc. The product request identifies a particular consumer. For example, a user may execute dedicated software on a transaction review device 130 or direct a browser to a portal provided by the server 110 via the network 170.

The liability estimation module 230 retrieves 420 account data for the account corresponding to the transaction data. For example, if the user has logged into a user interface for managing the account to review the transactions, the liability estimation module 230 may retrieve the account data from memory or a datastore. As described previously, the account data can include information about the organization that holds the account (e.g., industry and type of organization) as well as aggregate usage data (e.g., average transaction amounts, minimum and maximum transactions, etc.).

The liability estimation module 230 predicts 430 classifications for at least some of the transactions identified in the transaction data. In one embodiment, the liability estimation module 230 applies a trained transaction classification module to the transaction data and account data to generate classification predictions. Each classification predictions may identify a specific classification and a corresponding likelihood that the classification is correct.

The liability estimation module 230 confirms 440 the classifications for transactions. In embodiments where the liability estimation module 230 generates multiple predicted classifications for a transaction, it may select one to present to the user (e.g., the most likely classification) and the user may confirm the selected classification or provide an alternative classification. Alternatively, the liability estimation module 230 may present multiple classifications to the user for the user to confirm by selecting the appropriate one (or select an alternative classification). The liability estimation module 230 may initially select no classification to recommend for some transactions (e.g., where the generated predictions all have a likelihood below a threshold) and present such transactions to the user with a prompt to select/confirm a classification. In some embodiments, predictions that exceed a threshold likelihood may be automatically confirmed by the liability estimation module 230 without further user input.

The liability estimation module 230 estimates 450 the tax liability for the account based on the classification. In one embodiment, the liability estimation module 230 maps the classifications generated by the classification module 220 to classifications used by one or more relevant tax authorities. Thus, the liability estimation module 230 may evaluate the tax impact of each transaction to estimate the overall tax liability of the account. The liability estimation module 230 provides 460 the estimated tax liability for display to the user (e.g., in a user interface of a transaction review device 130).

### Computing System Architecture

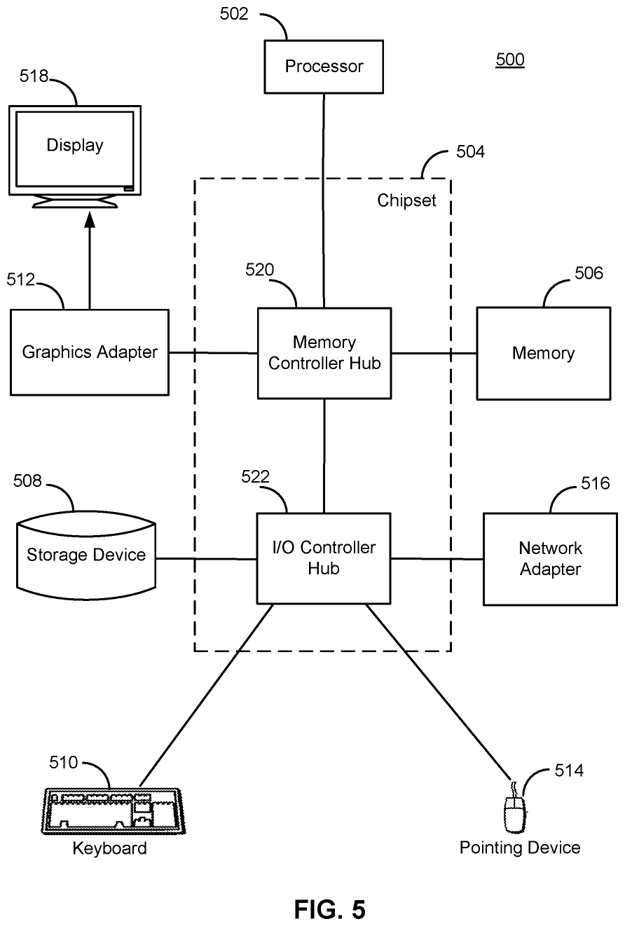

FIG. 5 is a block diagram of an example computer 500 suitable for use as a server 110, consumer client device 120, or provider client device 130. The example computer 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, keyboard 510, pointing device 514, and network adapter 516 are coupled to the I/O controller hub 522. Other embodiments of the computer 500 have different architectures.

In the embodiment shown in FIG. 5, the storage device 508 is a non-transitory computer-readable storage medium such as a hard drive, compact disk read-only memory (CD-ROM), DVD, or a solid-state memory device. The memory 506 holds instructions and data used by the processor 502. The pointing device 514 is a mouse, track ball, touch-screen, or other type of pointing device, and may be used in combination with the keyboard 510 (which may be an on-screen keyboard) to input data into the computer system 500. The graphics adapter 512 displays images and other information on the display 518. The network adapter 516 couples the computer system 500 to one or more computer networks, such as network 170.

The types of computers used by the entities of FIGS. 1 and 2 can vary depending upon the embodiment and the processing power required by the entity. For example, the server 110 might include multiple blade servers working together to provide the functionality described. Furthermore, the computers can lack some of the components described above, such as keyboards 510, graphics adapters 512, and displays 518.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for estimating the tax liability of an account using a transaction classification model. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
receiving transaction data for an account, the transaction data including data describing transactions involving the account;
retrieving account data for the account;
applying a machine-learning transaction classification model to the transaction data and the account data to generate predicted classifications for at least some of the transactions;
estimating a tax liability of the account based on the predicted classifications; and
providing the estimated tax liability for display.

2. The computer-implemented method of claim 1, wherein the transaction data for a given transaction includes one or more of: a transaction amount, a payer, a payee, merchant details, a PPS transaction type, a payment method, an acceptance method, an identifier of the payment, or a description of the transaction.

3. The computer-implemented method of claim 1, wherein the account data includes one or more of: an mean transaction amount, a median transaction amount, a minimum historical transaction amount, a maximum historical transaction amount, a total amount of transactions for a preceding time period, an industry classification of an organization that holds the account, or an SIC description of the organization that holds the account.

4. The computer-implemented method of claim 1, wherein the predicted classifications include, for each of at least some of the transactions, a predicted classification and a likelihood metric indicating a probability that the predicted classification is correct.

5. The computer-implemented method of claim 1, wherein the predicted classifications include, for a first transaction of the transactions, a plurality of predicted classifications and a plurality of likelihood metrics indicating a probability that a corresponding one of the predicted classifications is correct.

6. The computer-implemented method of claim 1, further comprising confirming at least some of the predicted classifications, wherein the tax liability is estimated using confirmed classifications.

7. The computer-implemented method of claim 6, wherein confirming at least some of the predicted classifications comprises:
providing, for display at a transaction review device, a predicted classification for a transaction in conjunction with a likelihood metric indicating a probability that the predicted classification is correct;
receiving, from the transaction review device, an indication of user input confirming the classification or providing an alternative classification as a confirmed classification.

8. The computer-implemented method of claim 1, wherein the machine-learning transaction classification model was iteratively trained by a process comprising:
obtaining training data including historical transaction data and historical account data, the historical transaction data labeled with ground truth classifications;
applying the machine-learning transaction classification model to the training data to generate predictions;
evaluating the predictions using the ground truth classifications; and
updating the machine-learning transaction classification model responsive to the predictions failing to satisfy one or more accuracy metrics.

9. The computer-implemented method of claim 1, wherein estimating the tax liability of the account comprises mapping the predicted classifications to classifications used by a relevant tax authority.

10. A non-transitory computer-readable medium storing executable computer program code that, when executed by a computing system, causes the computing system to perform operations comprising:
receiving transaction data for an account, the transaction data including data describing transactions involving the account;
retrieving account data for the account;
applying a machine-learning transaction classification model to the transaction data and the account data to generate predicted classifications for at least some of the transactions;
estimating a tax liability of the account based on the predicted classifications; and
providing the estimated tax liability for display.

11. The non-transitory computer-readable medium of claim 10, wherein the transaction data for a given transaction includes one or more of: a transaction amount, a payer, a payee, merchant details, a PPS transaction type, a payment method, an acceptance method, an identifier of the payment, or a description of the transaction.

12. The non-transitory computer-readable medium of claim 10, wherein the account data includes one or more of: an mean transaction amount, a median transaction amount, a minimum historical transaction amount, a maximum historical transaction amount, a total amount of transactions for a preceding time period, an industry classification of an organization that holds the account, or an SIC description of the organization that holds the account.

13. The non-transitory computer-readable medium of claim 10, wherein the predicted classifications include, for each of at least some of the transactions, a predicted classification and a likelihood metric indicating a probability that the predicted classification is correct.

14. The non-transitory computer-readable medium of claim 10, wherein the predicted classifications include, for a first transaction of the transactions, a plurality of predicted classifications and a plurality of likelihood metrics indicating a probability that a corresponding one of the predicted classifications is correct.

15. The non-transitory computer-readable medium of claim 10, wherein the operations further comprise confirming at least some of the predicted classifications, wherein the tax liability is estimated using confirmed classifications.

16. The non-transitory computer-readable medium of claim 15, wherein confirming at least some of the predicted classifications comprises:
providing, for display at a transaction review device, a predicted classification for a transaction in conjunction with a likelihood metric indicating a probability that the predicted classification is correct;
receiving, from the transaction review device, an indication of user input confirming the classification or providing an alternative classification as a confirmed classification.

17. The non-transitory computer-readable medium of claim 10, wherein the machine-learning transaction classification model was iteratively trained by a process comprising:
obtaining training data including historical transaction data and historical account data, the historical transaction data labeled with ground truth classifications;
applying the machine-learning transaction classification model to the training data to generate predictions;
evaluating the predictions using the ground truth classifications; and
updating the machine-learning transaction classification model responsive to the predictions failing to satisfy one or more accuracy metrics.

18. The non-transitory computer-readable medium of claim 10, wherein estimating the tax liability of the account comprises mapping the predicted classifications to classifications used by a relevant tax authority.

19. A non-transitory computer-readable medium storing a machine-learning transaction classification model, wherein the machine-learning transaction classification model was produced by a process comprising:
obtaining training data including historical transaction data and historical account data, the historical transaction data labeled with ground truth classifications;
applying the machine-learning transaction classification model to the training data to generate predictions;
evaluating the predictions using the ground truth classifications; and
updating the machine-learning transaction classification model responsive to the predictions failing to satisfy one or more accuracy metrics.

20. The non-transitory computer-readable medium of claim 19 further storing instructions that, when executed by a computing system, cause the computing system to perform operations comprising:
receiving transaction data for an account, the transaction data including data describing transactions involving the account;
retrieving account data for the account;
applying the machine-learning transaction classification model to the transaction data and the account data to generate predicted classifications for at least some of the transactions;
estimating a tax liability of the account based on the predicted classifications; and
providing the estimated tax liability for display.
